(19) United States
(12) Patent Application Publication
(10) Pub. No.: US 2004/0050323 A1
(43) Pub. Date: Mar. 18, 2004

(54) Apparatus for controlling coating weight on strip in continuous galvanizing process

(76) Inventor: Hong-Kook Chae, Kyungsangbook-do (KR)

Correspondence Address: WEBB ZIESENHEIM LOGSDON ORKIN & HANSON, P.C., 700 KOPPERS BUILDING, 436 SEVENTH AVENUE, PITTSBURGH, PA, 15219, US

(21) Appl. No.: 10/433,251

(22) PCT Filed: Aug. 23, 2002
(86) PCT No.: PCT/KR02/01591

(30) Foreign Application Priority Data
Aug. 24, 2001 (KR) 20001/51242
Dec. 21, 2001 (KR) 2001/82222
Dec. 21, 2001 (KR) 2001/82223

(51) Int. Cl. B05C 11/02; B05C 3/02; B05C 11/00

(52) U.S. Cl. 118/400; 118/413; 118/423; 118/100; 118/665

(57) ABSTRACT

An apparatus for controlling coating weight on a steel strip in a continuous hot dip galvanizing process, in which the coating weight is controlled through air wiping after the steel strip passes through a molten zinc coating bath. More particularly, the apparatus keeps the steel strip equidistant from each air knife, uniformly distributes a spray pressure of the air knives in a widthwise direction of the steel strip, and minimizes variation in coating weights on both surfaces of the steel strip. Furthermore, when two steel strips that are different in thickness are continuously hot dip galvanized, the apparatus predicts the movement of the passing line of the steel strips and accurately controls the positions of the air knives. As a result, product deficiencies such as insufficient coating can be reduced and zinc loss due to excess coating can be minimized.

### TECHNICAL FIELD

The present invention relates to an apparatus for controlling coating weight on a steel strip in a continuous hot dip galvanizing process, in which the coating weight is controlled through air wiping after the steel strip passes through a molten zinc coating bath. More particularly, the present invention relates to an apparatus for controlling coating weight on a steel strip in a continuous hot dip galvanizing process, in which a difference between an actual coating weight and a coating weight ordered by the customer is minimized, resulting from optimizing a distance between the steel strip and air knives which control coating weight by spraying air jets on the steel strip that has passed through a molten zinc coating bath under a predetermined pressure, and/or a spray pressure of the air knives.

### BACKGROUND ART

Generally, a coating process is applied to provide steel strips with corrosion resistance and pleasing appearance. By way of examples of representative coating processes, there are a hot dipping process wherein steel strips pass through a molten metal coating bath, and an electroplating process using electrolytes.

The hot dipping process is a process whereby a molten metal (such as molten zinc) is adhered to both surfaces of a steel strip that has passed through a molten metal coating bath. This requires separate equipment to uniformly control coating weight on the steel strip.

An air wiping process has been conventionally used to control coating weight on a steel strip. The process can control the coating weight of metal by spraying air jets on both surfaces of the steel strip that has passed through a coating bath under an appropriate air pressure through air knives.

It is important to maintain a uniform coating weight on a steel strip in a hot dipping process. To this end, a distance between the steel strip and air knives, and a spray pressure of the air knives, which are the most important factors in the air wiping process, are required to be controlled.

FIG. 1 is a schematic illustration of a conventional continuous hot dip galvanizing equipment using an air wiping process. While a steel strip 1 passes through a molten zinc coating bath 2 through a sink roll 5, molten zinc adheres to both surfaces of the steel strip 1. The steel strip that has passed through the molten zinc coating bath 2 is transported to a space defined between a first and a second air knife 3, 4 that have been installed on the upper side of the molten zinc coating bath. At this time, the air knives 3, 4 spray air jets of a predetermined pressure on the steel strip 1 at front and back sides of the steel strip 1, thereby to wipe off excess molten zinc and ensure that molten zinc is uniformly distributed on the steel strip 1. In FIG. 1, reference numeral 6 indicates a stabilizing roll designed for guiding the steel strip that has passed through the molten zinc coating bath 2 toward the space defined between the air knives 3, 4, and reference numeral 8 indicates a pressure adjusting valve that is installed on an air line which is connected with the air knives 3, 4.

With respect to the above continuous hot dip galvanizing process using air wiping, the surface of the steel strip 1 and the respective nozzles of the first and the second air knife 3, 4 must be parallel with each other in a widthwise direction (d) of the steel strip 1. Furthermore, a distance between the nozzle of the first air knife 3 and the front side of the steel strip 1 must be the same as that between the nozzle of the second air knife 4 and the back side of the steel strip 1.

Coating weight on the steel strip that has passed through the space defined between the first and second air knives 3, 4 increases in inverse proportion to distances between the respective nozzles of the first and the second air knife 3, 4 and the steel strip 1. For this reason, if coating weight on the steel strip 1 is to be uniformly distributed in a widthwise direction (d) of the steel strip 1, the steel strip 1 and the respective nozzles of the first and the second air knife 3, 4 must be parallel with each other. As well, if coating weight on the front side of the steel strip is to be the same as that on the back side of the steel strip, the steel strip must be kept equidistant from each air knife.

A feedback process was conventionally used in order to control distances between the steel strip 1 and each of the first and the second air knife 3, 4. That is, first, widthwise direction coating weights on a coated steel strip (i.e., a steel strip that has passed through a space defined between air knives) are measured. Then, when these measurements are different, motors M1 to M4 are used to adjust positions of the first and the second air knife 3, 4.

However, such a conventional process requires a large amount of time to allow the surface of steel strip and the respective nozzles of air knives to be parallel with each other. For this reason, there is a serious problem in that coating weight is not uniformly distributed in a widthwise direction (d) of the steel strip or coating weight on the front side of the steel strip is not the same as that on the back side of the steel strip.

Meanwhile, with respect to a continuous hot dip galvanizing process whereby steel strips to be coated are connected with each other in order to improve work efficiency, steel strips that are different in thickness can be connected with each other.

FIGS. 2(a) and (b) are schematic illustrations of a continuous hot dip galvanizing process. Where a welded portion P joining two steel strips 1a, 1b that are different in thickness passes through a space defined between a first and a second air knife 3, 4, the passing line of the steel strips is moved due to action of a stabilizing roll 6 on the steel strips 1a, 1b.

Such a movement of the passing line of the steel strips differentiates a distance between the front side of the steel strips and the first air knife 3 from a distance between the back side of the steel strips and the second air knife 4. Resultantly, the coating weights for the front side and the back side of the steel strips are different.

In order to overcome the above problem, conventionally, immediately before a welded portion joining two steel strips that are different in thickness, passes through air knives, operators adjust a distance between the first and the second air knife 3, 4 according to their discretion. After the welded portion completely passes through the first and the second air knife 3, 4, a coating weight sensor (not shown) that is installed on a rear position about 100 m from the first and the second air knife 3, 4 measures respective coating weights on the front and the back side of the steel strips. Through these measurements, a difference between coating weights on the front side and the back side of the steel strips, depending on the movement of the passing line of the steel strips, is determined. Based on such a difference, a distance between the air knives can be gradually feedback controlled.

In this case, however, a large amount of time is required to equalize respective coating weights on the front and the back side of the steel strips, thereby resulting in poorly coated steels being produced.

Meanwhile, with respect to such a continuous hot dip galvanizing process using air wiping, where a desired coating weight or a feed rate of steel strip is changed, it is necessary to appropriately adjust the spray pressure of the air knives.

To this end, operators conventionally adjusted the spray pressure of air knives according to variations in a feed rate and a desired coating weight of a steel strip according to their discretion. Alternatively, they utilized existing tables representing variations in the set pressure value of the air knives depending on variation in a feed rate of the steel strip.

In this case, however, the adjustments of operators may be incorrect. In the case of utilizing the existing tables, it is difficult to tune all values on the tables to air knife characteristics that are revised whenever the air knife is repaired, and rapid pressure control is not accomplished, thereby practical usage thereof being inadvisable.

In summary, in order to minimize a difference between a desired coating weight and an actual coating weight, it is necessary to correctly change the set pressure value of air knives when the thickness and the feed rate of a steel strip are changed. If the set pressure value of the air knives is incorrectly changed, insufficient coating or excess coating frequently occurs. For this reason, the quality of products becomes worse. Furthermore, in case of excess coating, molten zinc is used in an amount more than is necessary, thereby resulting in additional costs being incurred.

### DISCLOSURE OF THE INVENTION

Therefore, the present invention has been made in view of the above problems of a conventional hot dip galvanizing process using air wiping, and it is an object of the present invention to provide an apparatus for controlling coating weight on a steel strip in a continuous hot dip galvanizing process, in which the steel strip and spray nozzles are parallel with each other in a widthwise direction of the steel strip and the steel strip is kept equidistant from each spray nozzle, resulting in the steel strip being positioned in the center of a space defined between air knives and being parallel with each nozzle.

It is another object of the present invention to provide an apparatus for controlling coating weight on a steel strip in a continuous hot dip galvanizing process using air wiping, in which the spray pressure of air knives is appropriately adjusted depending on variation in the desired coating weight or the feed rate of the steel strip, resulting in minimizing a difference between an actual coating weight adhered to the steel strip and a desired coating weight.

It is yet another object of the present invention to provide an apparatus for controlling coating weight on a steel strip in a continuous hot dip galvanizing process using air wiping, in which when the connection of two steel strips that are different in thickness passes through a space defined between air knives, the movement of the passing line of the steel strips is predicted depending on strip thickness change and then distances between the steel strip and the air knives are adjusted, thereby minimizing differential coating weight for the front and the back side of the steel strip.

In accordance with the present invention, the above and other objects can be accomplished by the provision of an apparatus for controlling coating weight on a steel strip in a Continuous hot dip galvanizing process, in which a first and a second air knife are equipped to control coating weight on the steel strip by spraying air jets of a predetermined pressure on both surfaces of the steel strip that has passed through a molten zinc coating bath, comprising:

multiple distance measuring means, which is installed to be separated by a predetermined distance from each other in the center of a support shaft that is positioned in a line with the second air knife and measures a distance between the steel strip and the air knife;

a distance adjusting means, which adjusts respective distances between each of the first and the second air knife and the steel strip while moving forward and backward both ends of each of the first and the second air knife;

a width measuring means, which measures the width of the steel strip; and

a position adjusting means for the distance measuring means, which allows the distance measuring means to be positioned in a widthwise center of the steel strip depending on sensing results of the width measuring means.

The width measuring means may consist of a first and a second width sensor, each of which comprises a light emitting part on the first air knife and a light receiving part on the support shaft that is positioned in a line with the second air knife and is installed on opposite one ends of the first and the second air knife, and which determine the position and the width of the steel strip by detection of light by the light receiving part when the light emitting part transmits light.

The position adjusting means may consist of a position adjusting motor which moves the support shaft in a widthwise direction of the steel strip, and in which the light receiving parts of the first and the second width sensor and the multiple distance measuring means are installed on the support shaft; a motor position control device which drives the position adjusting motor; and a first logic unit, which calculates the moving value of the position adjusting motor and then puts the calculated value into the motor position control device in order to equalize the amounts of light detected on the respective light receiving parts of the first and the second width sensor.

The first logic unit may produce the moving value of the distance measuring means as follows:

ΔGc=(Nws−Nds)×Pss

wherein, ΔGc is a moving value of the distance measuring means, Nws is the number of light-sensing photodiodes in the first width sensor, Nds is the number of light-sensor, photodiodes in the second width sensor, and Pss is a distance between photodiodes.

The distance measuring means may consist of three or more distance sensors that are positioned to be separated by a predetermined distance from each other.

The distance adjusting means may consist of four or more distance adjusting motors, which move forward and backward in a steel strip direction while being connected to both ends of each of the first and the second air knife; a second logic unit, which calculates the moving values of both ends of each of the first and the second air knife using a distance between the steel strip and the second air knife that is measured by the distance sensors to thereby keep the steel strip equidistant from each air knife and to keep the steel strip parallel with each air knife; and four or more motor position control devices which move the distance adjusting motors as far as the moving values of both ends of each of the first and the second air knife output from the second logic unit.

The second logic unit may define an X-Y coordinate plane spanned by the X-axis of the forward/backward movement direction of the first and the second air knife and the Y-axis of the widthwise direction of the steel strip using a point as the origin; represent the curve of the steel strip on the X-Y coordinate plane as the following formula:

S(x):y=ax²+bx+c

(wherein, S(x) is a function to the curve of the steel strip on the X-Y coordinate plane, and a, b and c are coefficients of S(x)); change multiple measurements obtained from the multiple distance measuring means into the X-Y coordinate values; put the X-Y coordinate values into the function S(x) to obtain coefficients a, b and c; put the obtained S(x) into the following formula:

$$Δ Y = \frac{[ {\int }^{W} ( S ( x ) - {L}_{T} ( x ) ) ⅆ x - {\int }^{W} ( {L}_{B} ( x ) - S ( x ) ) ⅆ x ]}{2 W}$$

(wherein, ΔY represents an average moving value of the first and the second air knife, W represents a width size of the steel strip detected by the width sensor, L_{T}(X) represents a linear equation of the nozzle of the first air knife, and L_{B}(X) represents a linear equation of the nozzle of the second air knife) thereby to obtain an average moving value of the first and the second air knife, ΔY; calculate the moving values of both ends of the first and the second air knife, ΔYds and ΔYws using the following formula:

$$Δ {Y}_{d S} = \frac{( {D}_{WS} - {D}_{dS} )}{2} \frac{M}{{G}_{SS}} , Δ {Y}_{WS} = - \frac{( {D}_{WS} - {D}_{dS} )}{2} \frac{( L - M )}{{G}_{SS}}$$

(wherein, ΔYds is a moving value of one end of the first and the second air knife, ΔYws is a moving value of the other end of the first and the second air knife, M is a straight line distance between a distance measuring means positioned at the center among multiple distance measuring means and a distance adjusting means which is connected with one end of the second air knife, and L is a distance between the two distance adjusting means which are positioned at both ends of the second air knife); and then calculate final moving values of both ends of each of the first and the second air knife, ΔY1, ΔY2, ΔY3 and ΔY4 using the following formulas:

ΔY1=−ΔY−ΔYws

ΔY2=−ΔY−ΔYds

ΔY3=ΔY+ΔYws

ΔY4=ΔY+ΔYds

(wherein, ΔY1 is a final moving value of one end (WS) of the first air knife, ΔY2 is a final moving value of the other end (DS) of the first air knife, ΔY3 is a final moving value of one end (WS) of the second air knife, and ΔY4 is a final moving value of the other end (DS) of the second air knife).

In accordance with another aspect of the present invention, there is provided an apparatus for controlling coating weight on a steel strip in a continuous hot dip galvanizing process, in which a first and a second air knife are equipped to control coating weight on the steel strip by spraying air jets of a predetermined pressure on both surfaces of the steel strip that has passed through a molten zinc coating bath, comprising:

a position adjusting means for adjusting positions of the first and the second air knife;

a welded portion sensing means for detecting a changing position of a welded portion joining two steel strips that are different in thickness in a molten zinc coating bath;

a distance measuring means for measuring a distance between the second air knife and the steel strip;

a moving distance predictive logic means for calculating a moving distance of each of the first and the second air knife by calculating a thickness variation of a preceding steel strip and a following steel strip welded thereto and a moving value of the passing line of the steel strips on the basis of thickness information of the steel strips;

a moving distance measuring logic means for calculating a moving distance of each of the first and the second air knife by calculating a moving value of the passing line of the steel strips before and after passage of the welded portion using a distance between the steel strip and the second air knife that is measured by the distance measuring means;

a parameter correction means for correcting the parameters of the moving distance predictive logic means in order to compensate for an error between the predicted a moving distance in the moving distance predictive logic means and the measured moving distance in the moving distance measuring logic means;

a switching means, which chooses between moving distances of the first and the second air knife output from the moving distance predictive logic means and those output from the moving distance measuring logic means, and then applies the chosen moving distance values to the position adjusting means; and

a switching control unit for applying the output value of the moving distance measuring logic means to the position adjusting means, with the exception of applying the output value of the moving distance predictive logic means to the position adjusting means during a predetermined time before and after the welded portion passes through the first and the second air knife, based on a changing position of the welded portion detected by the welded portion sensing means.

The moving distance predictive logic means may input thickness of each of the preceding/following steel strips and thickness difference therebetween into the following formula:

$$\hat{S} = α {T}_{1} \frac{Δ T}{\vert Δ T \vert} + βΔ T$$

(wherein Ŝ is a predicted moving value of the passing line, T₁ is a thickness of the preceding steel strip, ΔT is a thickness difference between the preceding steel strip and the following steel strip, and α and β are predictor variables), thereby to calculate a predicted moving value of the passing line of the steel strips and then produce a predicted moving distance of each of the first and the second air knife depending on the moving value of the passing line.

The moving distance measuring logic means may receive measured distance values between each of the preceding/following steel strips and the second air knife from the distance measuring means and then calculate an actual moving value of the passing line of the steel strips using the following formula:

S=(D₂−D₁)−(P₂−P₁)

(wherein, S is an actual moving value of the passing line, D₁ is a distance between the preceding steel strip and the second air knife, D₂ is a distance between the steel strip and the second air knife after passage of the welded portion, P₁ is a position of the second air knife before passage of the welded portion, and P₂ is a position of the second air knife after passage of the welded portion).

The parameter correction means may correct operating parameters of the moving distance predictive logic means according to the following formulas:

$$\begin{matrix}α ( t + 1 ) = α ( t ) + {γ}_{α} \frac{\partial ( S - \hat{S} )}{\partial α} = α ( t ) - {γ}_{α} {T}_{1} \frac{Δ T}{\vert Δ T \vert} \\ β ( t + 1 ) = β ( t ) + {γ}_{β} \frac{\partial ( S - \hat{S} )}{\partial β} = β ( t ) - {γ}_{β} Δ T\end{matrix} ,$$

(wherein, γ_{α}>γ_{β} are learning rates of α, β).

In accordance with another aspect of the present invention, there is provided an apparatus for controlling coating weight on a steel strip in a continuous hot dip galvanizing process, in which a first and a second air knife are equipped to control coating weight on the steel strip by spraying air jets of a predetermined pressure on both surfaces of the steel strip that has passed through a molten zinc coating bath, comprising:

a coating weight measuring means for measuring coating weight on the steel strip that has passed through the first and the second air knife;

a coating weight mathematical model for calculating coating weight variation using respective parameters α, β and γ for compensating for variations in a feed rate of the steel strip, a distance between each air knife and the steel strip, and a pressure of the air knives;

a parameter correction means for correcting the parameters α, β and γ in order to minimize a difference between an actual coating weight value measured in the coating weight measuring means and a calculated coating weight value calculated in the coating weight mathematical model;

a first pressure control means for adjusting spray pressure of the first and the second air knife to conform the coating weight of the steel strip to the desired coating weight when the desired coating weight of the steel strip is changed; and

a second pressure control means for adjusting spray pressure of the air knives to compensate for the coating weight variation depending on variation in the feed rate of the steel strip when the feed rate of the steel strip is changed, characterized in that the spray pressure of the first and the second air knife is adjusted using output values of the first pressure control means and/or the second pressure control means when the desired coating weight and/or the feed rate are changed during a continuous hot dip galvanizing process under a predetermined pressure.

The coating weight mathematical model may receive the feed rate variation of the steel strip (ΔV), the distance variation between the steel strip and the air knives (ΔD), and the pressure variation of the air knives (ΔP) according to the following formula:

ΔV=ln(Vₖ₊₁)−ln(Vₖ)

ΔD=ln(Dₖ₊₁)−ln(Dₖ)

ΔP=ln(Pₖ₊₁)−ln(Pₖ);

multiply above respective variations by corresponding parameters α, β and γ thereby to obtain the formula, ΔW=αΔV+βΔD+γΔP; and then calculate the coating weight variation, ΔW=ln(Wₖ₊₁)−ln(Wₖ).

The first pressure control means may produce the set pressure value of the air knives (Pₖ₊₁) at the desired coating weight of Tₖ₊₁ using the following formula when the desired coating weight of the steel strip is changed from Tₖ to Tₖ₊₁:

$$ln ( {P}_{k + 1} ) = ln ( {P}_{k} ) + \frac{ln ( {T}_{k + 1} ) - ln ( {T}_{k} )}{γ}$$

The second pressure control means may produce the set pressure value of the air knives (Pₖ₊₁) at the feed rate of Vₖ₊₁ using the following formula when the feed rate of the steel strip is changed from Vₖ to Vₖ₊₁:

$$ln ( {P}_{k + 1} ) = ln ( {P}_{k} ) + \frac{α [ ln ( {V}_{k + 1} ) - ln ( {V}_{k} ) ]}{γ}$$

The parameter correction means may correct the parameters α, β and γ using the following formulas when a difference between an actual coating weight measured in the coating weight measuring means and a calculated coating weight in the coating weight mathematical model is detected:

θₖ₊₁=θₖ+Kₖ₊₁[z_{k+z}−h′ₖ₊₁θₖ]

(wherein, zₖ₊₁=Δ\overline{Wₖ₊₁}=ln(\overline{Wₖ₊₁})−ln(\overline{Wₖ})

$$( wherein , {z}_{k + 1} = Δ \overline{{W}_{k + 1}} = ln ( \overline{{W}_{k + 1}} ) - ln ( \overline{{W}_{k}} ) \\ \begin{matrix}{h}_{k + 1} = ( \begin{matrix}\begin{matrix}Δ {V}_{k + 1} \\ Δ {D}_{k + 1}\end{matrix} \\ Δ {P}_{k + 1}\end{matrix} ) = ( \begin{matrix}\begin{matrix}ln ( {V}_{k + 1} ) - ln ( {V}_{k} ) \\ ln ( {D}_{k + 1} ) - ln ( {D}_{k} )\end{matrix} \\ ln ( {P}_{k + 1} ) - ln ( {P}_{k} )\end{matrix} ) \\ {θ}_{k} = ( \begin{matrix}\begin{matrix}{α}_{k} \\ {β}_{k}\end{matrix} \\ {γ}_{k}\end{matrix} ) , {θ}_{k + 1} = ( \begin{matrix}\begin{matrix}{α}_{k + 1} \\ {β}_{k + 1}\end{matrix} \\ {γ}_{k + 1}\end{matrix} ) )\end{matrix}$$

In accordance with yet another aspect of the present invention, there is provided a system for controlling coating weight on a steel strip in a continuous hot dip galvanizing process, in which a first and a second air knife are equipped to control coating weight on the steel strip by spraying air jets of a predetermined pressure on both surfaces of the steel strip that has passed through a molten zinc coating bath, comprising:

a first coating weight control apparatus, measuring distance values between the steel strip and each of the first and the second air knife at multiple measuring points and changing positions of both ends of each of the air knives using the measured multiple distance values, thereby to align the steel strip to be parallel with each air knife and to keep the steel strip equidistant from each air knife;

a second coating weight control apparatus, changing position of each of the first and the second air knife thereby to correct the movement of the passing line depending on thickness difference of two steel strips during a predetermined time before and after passage of the welded portion of the two steel strips;

a third coating weight control apparatus, varying a spray pressure depending on variation in the desired coating weight and/or the feed rate of the steel strip;

an air knife distance control device, adjusting positions of both ends of each of the first and the second air knife using the second coating weight control apparatus for a predetermined time before and after passage of the welded portion and adjusting positions of both ends of each of the first and the second air knife using the first coating weight control apparatus after passage of the welded portion; and

an air knife pressure control device, adjusting a spray pressure to be sprayed from the first and the second air knife using the third coating weight control apparatus. Therefore, the system can satisfy the customer's requirements regardless of variation in a continuous hot dip galvanizing process.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic illustration of a conventional continuous hot dip galvanizing equipment using air wiping;

FIGS. 2(a) and (b) are views showing continuous coating of steel strips that are different in thickness in a continuous hot dip galvanizing process using air wiping;

FIG. 3 is a schematic illustration showing the structure of a coating weight control apparatus according to the first embodiment of the present invention;

FIG. 4 is a block diagram showing the structure of a coating weight control apparatus according to the first embodiment of the present invention;

FIG. 5 is a schematic illustration of a coating weight control apparatus according to the second embodiment of the present invention;

FIG. 6 is a flow chart showing the control flow of a coating weight control apparatus according to the second embodiment of the present invention;

FIG. 7 is a block diagram showing a coating weight control apparatus according to the third embodiment of the present invention; and

FIG. 8 is a block diagram showing a coating weight control system according to the fourth embodiment of the present invention.

### BEST MODE FOR CARRYING OUT THE INVENTION

Hereinafter, the constitutional elements and acting effects of the present invention will be described in more detail with reference to various embodiments shown in accompanying figures.

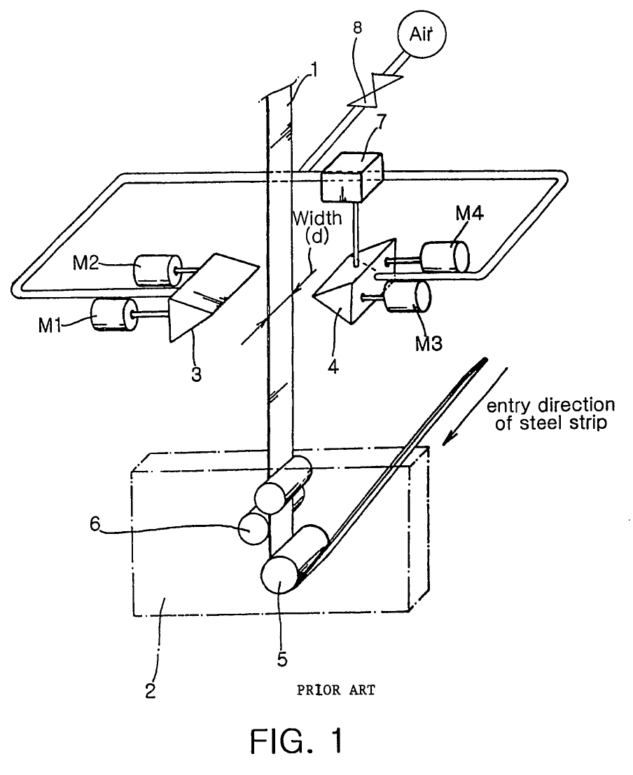

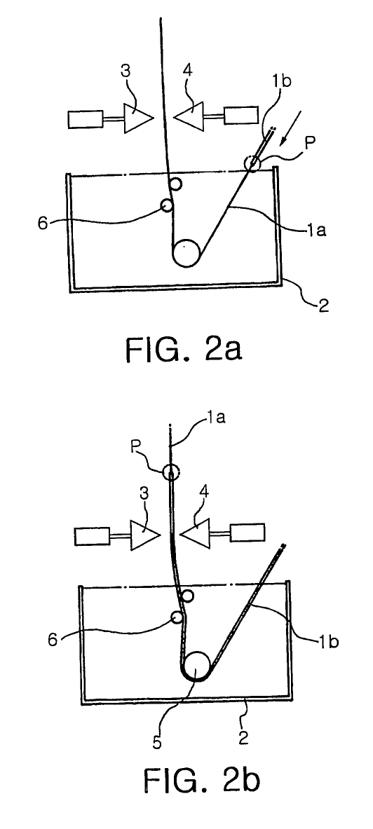

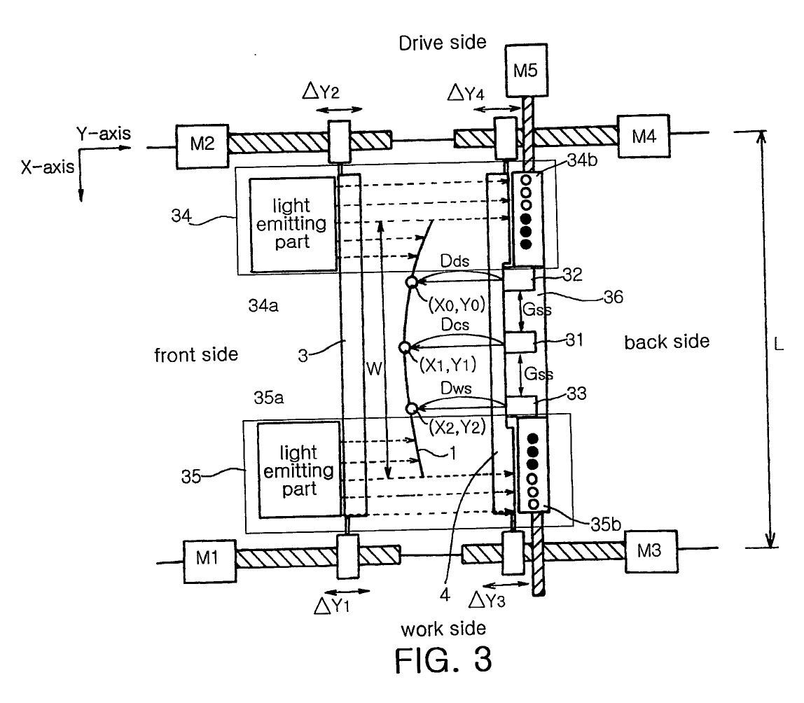

FIG. 3 is a schematic illustration showing the structure of a coating weight control apparatus according to the first embodiment of the present invention. The constitutional elements of FIG. 3 which are the same as those used in FIGS. 1 and 2 are expressed using the same reference numerals.

As shown in FIG. 3, a coating weight control apparatus according to the present invention comprises four distance adjusting motors M1, M2, M3, M4, which adjust distances between a steel strip 1 and each of the first and the second air knife 3, 4 in a X-axis direction by moving positions of both ends of each of the first and the second air knife 3, 4 thereby to align the steel strip 1 to be parallel with each spray nozzle; three distance sensors 31, 32, 33, which are installed at the back side of the steel strip 1 and measure a distance between the second air knife and the steel strip 1; two width sensors 34, 35, each of which is positioned at opposite one ends of the first and the second air knife 3, 4 and detects widthwise position of each of the air knives 3, 4 relative to the steel strip 1; and a position adjusting motor M5, which is connected with a support shaft that supports light receiving parts 34b, 35b of the width sensors 34, 35 and the distance sensors 31, 32, 33 and which can move in a X-axis direction.

With respect to the width sensors 34, 35, as shown in FIG. 3, light emitting parts 34a, 35a are positioned at both ends of the first air knife 3, and light receiving parts 34b, 35b are positioned at both ends of the second air knife 4 opposite to the light emitting parts 34a, 35a. The light receiving parts 34b, 35b receive the light from the light emitting parts 34a, 35a. White circles indicate regions where the light receiving parts 34b, 35b receive light and black circles indicate regions where the light receiving parts 34b, 35b do not receive light because light is blocked by the steel strip 1. For the purpose of convenience, the upper side of FIG. 3 is designated as Drive Side (hereinafter, referred to as DS) and the lower side of FIG. 3 is designated as Work Side (hereinafter, referred to as WS). Left side indicates the front side of the steel strip and right side indicates the back side of the steel strip.

Although not shown in FIG. 3, the apparatus further comprises a control section which controls the whole operation of the apparatus including the respective operations of the constitutional elements. The control section preferably comprises a microprocessor and the detailed description thereof will be described later.

The distance sensors 31, 32, 33 are responsible for measuring respective distances Dws, Dcs and Dds of three points positioned in a widthwise direction of the steel strip 1. They are attached to the second air knife 4 and thus move together therewith. In this case, a laser sensor or an eddy current sensor can be used as a sensor for measuring the distance to the steel strip 1 from the second air knife but there are no limited to particular sensors. The three distance sensors 31, 32, 33 are installed to be separated by a predetermined distance Gss from each other. Respective measurements of the two outer distance sensors 32, 33 must be the same. Therefore, the widthwise direction of the steel strip is parallel with the nozzle of the back side air knife.

That is, the distance value Dds measured in the DS distance sensor 32 must be the same as that Dws measured in the WS distance sensor 33 in order for the steel strip 1 to be parallel with the nozzle of the back side air knife 4. To this end, the central distance sensor 31 needs to be positioned in a widthwise center of the steel strip 1. To satisfy this requirement, a driving mechanism is required to move the distance sensors 31, 32, 33 and the light receiving parts 34b, 35b in a widthwise direction of the steel strip.

In this regard, the distance sensors 31, 32, 33 and the light receiving parts 34b, 35b are installed at a mobile shaft that is connected with the fifth motor M5. The width sensors 34, 35 detect the edges of the steel strip 1 and the width of the steel strip is estimated based on the detection result. Finally, the fifth motor M5 is adjusted so that the distance sensor 31 is positioned in a widthwise center of the steel strip 1. That is, where the two outer width sensors 34, 35 have the same number of light sensing regions, the center-positioned distance sensor 31 is positioned in a widthwise center of the steel strip 1.

As shown in FIG. 3, the light emitting parts 34a, 35a of the width sensors 34, 35 are installed at both ends of the first air knife 3. The light receiving parts 34b, 35b thereof are installed at both ends of the support shaft 36 that is positioned in a line with the second air knife 4 in a state that are opposite to the light emitting parts 34a, 35a. Photodiodes are arranged in a line in a widthwise direction of the steel strip in the inside of the light receiving parts 34b, 35b. Therefore, if the light receiving parts receive light from the light emitting parts 34a, 35a, a predetermined amount of current is output. Such a width sensing manner has widely been used in case of detecting the width of steel strips in steel mills. The above manner was applied to the present invention so that the distance sensors 31 to 33 are positioned in a widthwise center of the steel strip.

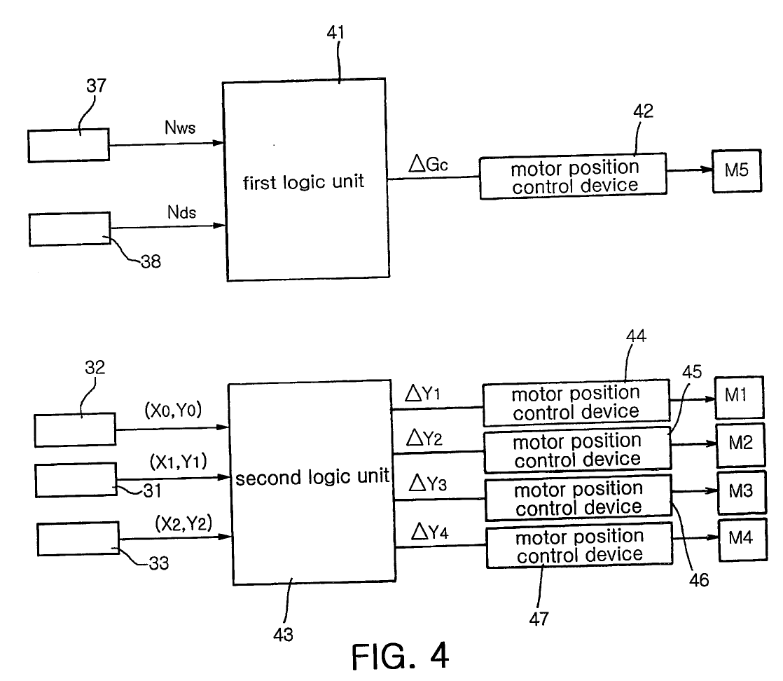

FIG. 4 is a block diagram showing the construction of a control section for controlling the coating weight control apparatus as shown in FIG. 3. FIG. 4(a) is a view showing a process for controlling the fifth motor M5 that is used as a transfer motor in order to position the distance sensors 31, 32, 33 in a widthwise center of the steel strip using width information obtained from the width sensors 34, 35. FIG. 4(b) is a view showing a process for controlling the distance adjusting motors M1, M2, M3, M4 that adjust positions of four points, that is, points of both ends of each of the two air knives using the measurements obtained from the distance sensors 31, 32, 33.

As shown in FIG. 4, the control section for controlling the coating weight control apparatus according to the present invention comprises a first logic unit 41, a motor position control device 42, a second logic unit 43, and motor position control devices 44 to 47. The number of the light sensing diodes Nws, Nds in the light receiving parts 34b, 35b is inputted from the first and the second width sensor 34, 35 into the first logic unit 41. Then, the first logic unit 41 calculates a motor moving value ΔGc for equalizing the number of the light sensing diodes in respective light receiving parts 34b, 35b. The motor position control device 42 drives the fifth motor M5 as far as the motor moving value calculated by the first logic unit 41. (XO, YO), (X1, Y1) and (X2, Y2), which are the distances to the steel strip from the second air knife measured by the three distance sensors 31 to 33 converted to X-Y coordinate values, are inputted into the second logic unit 43. The second logic unit 43 calculates respective motor moving values ΔY1, ΔY2, ΔY3 and ΔY4 in order to position the steel strip 1 to be parallel with each of the first and the second air knife 3, 4 and to keep the steel strip 1 equidistant from each air knife. The respective motor moving values calculated by the second logic unit 43 are inputted into the motor position control devices 44 to 47, which move motors M1 to M4 to respective desired positions.

The motor position control devices vary depending on the type of the motor to be controlled, and there are no limitations to particular motors or motor position control devices in the present invention.

The first logic unit 41 calculates a moving value (ΔGc) of the distance sensors according to the following formula 1:

ΔGc=(Nws−Nds)×Pss Formula 1

wherein, ΔGc is a moving value of the distance sensors in a widthwise direction of the steel strip, Nws is the number of light sensing photodiodes of the WS width sensor 35, Nds is the number of light sensing photodiodes of the DS width sensor 34, and Pss is a distance between photodiodes that are installed at the light receiving parts 34b, 35b of the width sensors 34, 35.

The motor position control device 42 drives the fifth motor M5 according to the moving value of the distance sensors 31 to 33 calculated using the formula 1. Therefore, if the distance sensors 31 to 33 are moved in a X-axis direction and thus Nws is equalized to Nds, the fifth motor M5 does not move any more. In this condition, the distance sensors 31 to 33 are positioned in a widthwise center of the steel strip 1.

The second logic unit 43 executes operations according to the following procedure and calculates respective moving values of four points, that is, end points of the air knives.

An average moving value of the first air knife 3 and the second air knife 4 is calculated in order to keep the steel strip 1 equidistant from each air knife. To this end, the curve of the steel strip is represented as a quadratic equation of the formula 2. In this case, the coordinate system is as shown in FIG. 3.

S(x):y=ax²+bx+c Formula 2

Three coordinate pairs, (x0, y0), (x1, y1) and (x2, y2) that are measured by the three distance sensors 31 to 33 all satisfy the formula 2. Therefore, the three coordinate pairs that are measured by the distance sensors 31 to 33 are put into the formula 2 thereby to form three simultaneous equations. If the simultaneous equations are solved, coefficients a, b and c for the formula 2 can be obtained.

Hereinafter, the action of the second logic unit 43 will be described in more detail.

Referring to FIG. 3, y-axis is perpendicular to the longitudinal axis of the air knives 3, 4 and x-axis is perpendicular to y-axis thereby to form a two-dimensional x-y coordinate plane. Any point can be selected as the origin (0,0) and the curve of the steel strip is represented as the quadratic equation S(x) of the formula 2.

The distances to the steel strip from the second air knife detected by the three distance sensors 31 to 33 are converted to x-y coordinate pairs, thereby to represent (x0,y0), (x1,y1) and (x2, y2) respectively. Where the three coordinate pairs, (x0,y0), (x1,y1) and (x2, y2) are put into the quadratic equation of the formula 2, the coefficients a, b and c can be solved. Therefore, a specific function describing the steel strip 1 is obtained.

The average moving value of the first air knife 3 and the second air knife 4 is calculated by substituting the above quadratic equation describing the steel strip 1 into the following formula 3:

$$Δ Y = \frac{[ {\int }^{W} ( S ( x ) - {L}_{T} ( x ) ) ⅆ x - {\int }^{W} ( {L}_{B} ( x ) - S ( x ) ) ⅆ x ]}{2 W} \qquad Formula 3$$

wherein, ΔY is an average moving value of the first and the second air knife 3, 4, W is a width of the steel strip measured in the width sensors 34, 35, LT(x) is a linear equation describing the spray nozzle of the first air knife 3, and LB(x) is a linear equation describing the spray nozzle of the second air knife 4.

The linear equations describing respective spray nozzles of the first and the second air knife 3, 4 represent the positions of respective spray nozzles of the first and the second air knife 3, 4 in the x-y coordinate system as described above. That is, the positions of respective spray nozzles of the first and the second air knife 3, 4 can be expressed as linear equations in the x-y coordinate plane as shown in FIG. 3. Preferably, the linear equation is expressed in the form of y=a′x+b′.

Then, the moving values of both ends of each of the first and the second air knife 3, 4 are calculated thereby to position respective spray nozzles of the first and the second air knife 3, 4 to be parallel with the steel strip 1.

To this end, the respective moving values of the first and the second air knife 3, 4 at DS and WS are calculated using the following formulas 4 and 5. The DS moving values are produced by the formula 4 and the WS moving values are produced by the formula 5.

$$\begin{matrix}Δ {Y}_{d S} = \frac{( {D}_{WS} - {D}_{dS} )}{2} \frac{M}{{G}_{SS}} & Formula 4 \\ Δ {Y}_{WS} = - \frac{( {D}_{WS} - {D}_{dS} )}{2} \frac{( L - M )}{{G}_{SS}} & Formula 5\end{matrix}$$

wherein, ΔYds is a DS moving value of the first and the second air knife 3, 4, ΔYws is a WS moving value of the first and the second air knife, M is an x-axis direction linear distance between the center-positioned width sensor 31 and the fourth motor M4, and L is a distance between WS distance adjusting motor M3 and DS distance adjusting motor M4 in the second air knife 4.

Finally, an average moving value ΔY for keeping the steel strip 1 equidistant from each of the first and the second air knife 3, 4, and respective moving values of WS/DS, ΔYws and ΔYds for keeping respective spray nozzles of the first and the second air knife 3, 4 parallel with each other are put into the formula 6, thereby to obtain respective moving values of the distance adjusting motors, M1, M2, M3 and M4.

ΔY1=−ΔY−ΔYws Formula 6

ΔY2=−ΔY−ΔYds

ΔY3=ΔY+ΔYws

ΔY4=ΔY+ΔYds

wherein, ΔY1 is a final moving value of the WS distance adjusting motor M1 of the first air knife 3, ΔY2 is a final moving value of the DS distance adjusting motor M2 of the first air knife 3, ΔY3 is a final moving value of the WS distance adjusting motor M3 of the second air knife 4, and ΔY4 is a final moving value of the DS distance adjusting motor M4 of the second air knife 4.

If the respective moving values of the distance adjusting motors, M1, M2, M3 and M4 are calculated, the corresponding respective motor position control devices 44 to 47 adjust the positions of the air knives. As a result, the steel strip 1 is always kept equidistant from each of the first and the second air knife 3, 4 and the spray nozzles are positioned to be parallel with each other in a widthwise direction of the steel strip 1.

In accordance with a coating weight control apparatus of the first embodiment of the present invention, respective average distances between each of the air knives and the steel strip are always equalized and respective nozzles of the air knives are positioned to be parallel with each other in a widthwise direction of the steel strip 1, resulting in a widthwise direction coating weight of the steel strip and a front and a back side coating weight of the steel strip being almost uniformly distributed. Therefore, product deficiencies such as insufficient coating and excess coating, and zinc loss can be prevented, resulting in production cost savings.

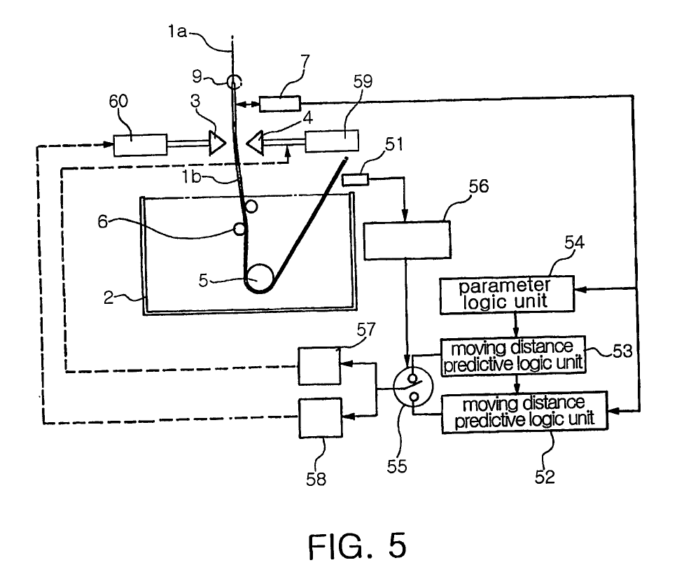

FIG. 5 is a schematic illustration of a coating weight control apparatus according to the second embodiment of the present invention. Paying attention to the fact that the moving value of the passing line depending on the variation in the thickness of the steel strip is proportional to the thickness and thickness variation of the steel strip, the moving value of the passing line is estimated. The error between the predictive value and an actual value is corrected after measuring an actual distance between the air knives and the steel strip in the welded portion. Hereinafter, the constitutional element and the action of the apparatus will be described in more detail with reference to the accompanying FIG. 5.

The coating weight control apparatus as shown in FIG. 5 comprises a distance measuring unit 7, a welded portion sensing unit 51, a moving distance measuring logic unit 52, a moving distance predictive logic unit 53, a parameter logic unit 54, a switching unit 55, a switching control unit 56, motor position control units 57, 58 and mobile motor units 59, 60. The distance measuring unit 7 is responsible for measuring a distance between the second air knife 4 and the steel strip 1. The welded portion sensing unit 51 is installed at an upstream part of the first and the second air knife 3, 4 in feed line of the steel strip 1 and detects the welded portion P where two steel strips 1a, 1b that are different in thickness are welded. Distances between each of the steel strips 1a, 1b and the second air knife 4 measured by the distance measuring unit 7 are put into the moving distance measuring logic unit 52, which then measures the moving value of the passing line of the steel strip 1 depending on a distance between the steel strip 1 and the second air knife 4 and calculates respective moving distances of the first and the second air knife 3, 4. The moving distance predictive logic unit 53 calculates the thickness variation between the preceding steel strip 1a and the following steel strip 1b that are positioned before and after the welded portion P together with predictive parameters, calculates the moving value of the passing line of the steel strip 1, and produces respective moving distances of the first and the second air knife 3, 4. The parameter logic unit 54 corrects the operating parameters to correct the error between the predicted passing line moving value in the moving distance predictive logic unit 53 and the measured passing line moving value in the moving distance measuring logic unit 22. The switching unit 55 selectively outputs respective moving distances of the first and the second air knife 3, 4 output from each of the moving distance predictive logic unit 53 and the moving distance measuring logic unit 52. The switching control unit 56 controls the switching unit 55 to choose the output value of the moving distance predictive logic unit 53 during a predetermined time after the welded portion has passed through a stabilizing roll 6, and to choose the output value of the moving distance measuring logic unit 52 except for the above predetermined time, based on a changing position of the welded portion detected by the welded portion sensing unit 51. The motor position control units 57, 58 are responsible for controlling the mobile motors of the first and the second air knife 3, 4 in order to move the first and the second air knife 3, 4 as far as the moving values output from the switching unit 55. Respective mobile motor units 59, 60 consist of one or more motors that move corresponding first and the second air knife 3, 4 forward and backward, and are driven under control of corresponding motor position control units 57, 58.

Although the motor units 59, 60 are simply represented in FIG. 5, the motor units 59, 60 consist of four motors, M1 to M4, which move both ends of each of the first and the second air knife 3, 4 as shown in FIG. 3. The production of the moving values of both ends of each of the first and the second air knife 3, 4 depending on movement of the steel strip 1 in the moving distance measuring logic unit 52 and the moving distance predictive logic unit 53 may be carried out according to the conventional methods or the method of the first embodiment as described above.

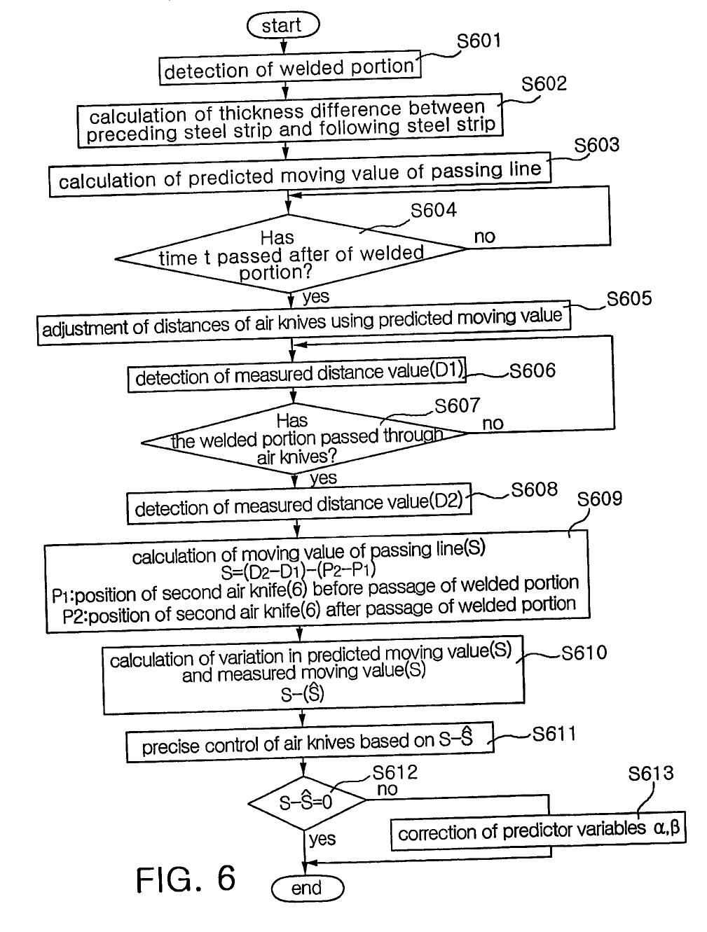

FIG. 6 is a flow chart showing the control flow of the coating weight control apparatus according to the second embodiment of the present invention. The principle of the coating weight control apparatus as shown in FIG. 5 will be described with reference to FIG. 6.

In accordance with the second embodiment of the present invention, two steel strips 1a, 1b that are different in thickness are welded and then continuously hot dip galvanized.

In this case, paying attention to the fact that when the steel strips 1a, 1b, which are different in thickness, pass through a space defined between the first and the second air knife 3, 4, the moving value of the passing line of the steel strips is proportional to the thickness and thickness variation of the steel strips, the coating weight control apparatus according to the second embodiment is designed and operates in the following manner.

When entry of the welded portion P is detected in the welded portion sensing unit 51 (S601), the moving distance predictive logic unit 53 calculates the variation (ΔT=T₂−T₁) in the thickness (T₁) of the preceding steel strip 1a and the thickness (T₂) of the following steel strip 1b at the border of the welded portion P (S602).

The predicted moving value (Ŝ) of the passing line is calculated according to the following formula 7 based on the above calculated thickness variation. The final moving value of the air knives (ΔP) output from the moving distance predictive logic unit 22 is the same as the predicted moving value of the passing line (Ŝ) (S603).

$$\hat{S} = α {T}_{1} \frac{Δ T}{\vert Δ T \vert} + βΔ T \qquad Formula 7$$

wherein, α and β are operating parameters for moving distance prediction.

The predicted moving value of the passing line is produced before the welded portion P passes through the stabilizing roll 6, and then whether a predetermined time has passed since the detection time of the welded portion P is checked. If the predetermined time has passed (S604), i.e., the welded portion P proceeds according to advancing direction of the steel strip from the welded portion sensing unit 51, passes through the stabilizing roll 6 and thus the passing line moves, the positions of the first and the second air knife 3, 4 are adjusted according to the predicted moving value of the passing line (Ŝ) (S605). To this end, the switching control unit 56 controls the switching action of the switching unit 55 after the first set time from output of the detection signal of the welded portion sensing unit 51 thereby to apply the output value of the moving distance predictive logic unit 53 to the motor position control units 57, 58. The motor position control units 57, 58 move respective mobile motor units 59, 60 of the first and the second air knife as far as the predicted moving value of the passing line (Ŝ) calculated in the moving distance predictive logic unit 53.

The first set time is the time required for the welded portion P to proceed from the detection position of the welded portion sensing unit 51 to the stabilizing roll 6.

After the welded portion P has passed through the first and the second air knife 3, 4, an actual distance between the following steel strip 1b and the second air knife is measured and any difference between measurements before and after passage of the welded portion is precisely equalized. In detail, before and after the welded portion P passes through the first and the second air knife 3, 4, respective distances between a reference air knife, i.e., the second air knife 4 positioned at the back side of the steel strip and the steel strips, D1 and D2 are measured using the distance measuring unit 51 (S606 to S608).

The moving distance measuring logic unit 52 calculates an actual moving value S of the passing line according to the formula 8 using a measured distance value D₁ between the preceding steel strip 1a and the second air knife 4, a measured distance value D₂ between the following steel strip 1b and the second air knife 4, the position P₁ of the second air knife 4 before the welded portion P passes through the first and the second air knife 3, 4, and the position P₂ of the second air knife 4 moved according to the prediction of the moving distance predictive logic unit 53 after the welded portion P passes through the first and the second air knife 3, 4. In this case, the final output value (ΔP) of the moving distance measuring logic unit 52 is obtained by subtracting the predicted moving value of the passing line (Ŝ) from the actual moving value (S) of the passing line (S609, S610).

S=(D₂−D₁)−(P₂−P₁) Formula 8

Therefore, the error is corrected by moving the first and the second air knife 3, 4 by the value obtained by subtracting the predicted moving value (Ŝ) from the actual moving value (S) (S611).

In detail, after the second set time has passed since the detection of the welded portion in the welded portion sensing unit 51, the switching control unit 56 controls the switching unit 55 to apply the output value of the moving distance measuring logic unit 52 to the motor position control units 57, 58. Then, the positions of the first and the second air knife 3, 4 are adjusted as far as a difference (S−Ŝ) between the actual moving value and the predicted moving value that is finally output from the moving distance measuring logic unit 52.

Where the predicted moving value (Ŝ) of the moving distance predictive logic unit 53 is the same as the actual moving value (S) of the passing line of the moving distance measuring logic unit 52, the output value applied to the motor position control units 57, 58 would be zero (0).

This indicates that accurate moving value prediction is accomplished in the moving distance predictive logic unit 53. On the contrary, where the predicted moving value (Ŝ) of the moving distance predictive logic unit 53 is different from the actual moving value (S) of the passing line of the moving distance measuring logic unit 53, parameters (α and β in formula 7) that have been used in the operation of the moving distance predictive logic unit 53 are incorrect and thus inaccurate prediction occurs. Therefore, the parameters, α and β must be reset. In this regard, in step S612, where a difference between the predicted moving value (Ŝ) and the actual moving value (S) is zero (0), the control steps are terminated, but otherwise, the parameters α and β are corrected as the following formula 9:

$$\begin{matrix}α ( t + 1 ) = α ( t ) + {γ}_{α} \frac{\partial ( S - \hat{S} )}{\partial α} = α ( t ) - {γ}_{α} {T}_{1} \frac{Δ T}{\vert Δ T \vert} \\ β ( t + 1 ) = β ( t ) + {γ}_{β} \frac{\partial ( S - \hat{S} )}{\partial β} = β ( t ) - {γ}_{β} Δ T\end{matrix} , \qquad Formula 9$$

wherein, γ_{α}>γ_{β} are learning rates of α and β.

The correction (S612, S613) of the parameters α and β for moving distance prediction operation is carried out in the parameter logic unit 54.

As described above, in accordance with the second embodiment of the present invention, two steel strips that are different in thickness are continuously hot dip galvanized. Before the welded portion passes through a space defined between the air knives, the passing line of the steel strips is adjusted using the thickness and thickness variation of the steel strips. Therefore, inaccuracy of conventional discretionary control by operators can be overcome. In the case wherein after the welded portion passes through a space defined between the air knives, the distance sensors measure an actual moving distance of the passing line of the steel strip and thus the distance between the air knives and the steel strip is accurately controlled. Therefore, variation in coating weight between the front and the back side of the steel strip, which is frequently generated in steel strips that are extended to several hundred meters from the welded portion in conventional continuous hot dip galvanizing, can be minimized. As the result, insufficient coating and excess coating in continuous hot dip galvanizing process are minimized and thus product deficiencies and zinc loss are prevented, resulting in production cost savings.

Although a distance between air knives and a steel strip is accurately controlled, where a desired coating weight varies, inaccurate coating may occur. To overcome this, the present invention controls a spray pressure depending on variation in the desired coating weight.

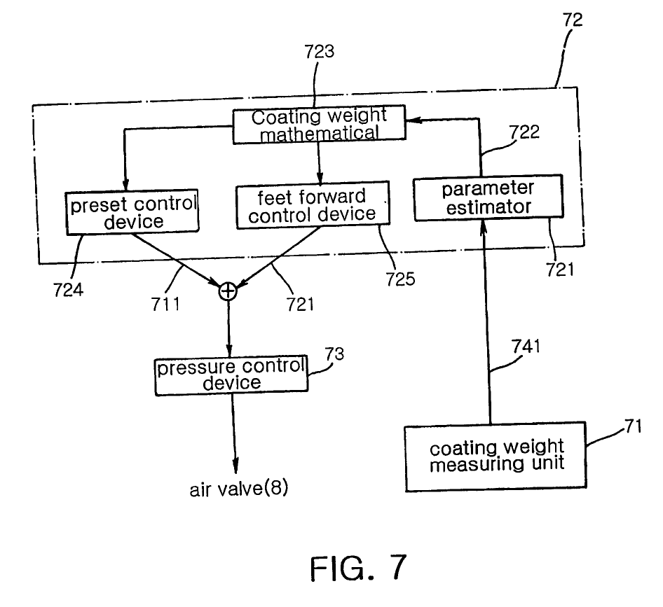

FIG. 7 is a block diagram showing a coating weight control apparatus according to the third embodiment of the present invention. The coating weight control apparatus comprises a coating weight measuring unit 71, a coating weight control unit 72, and a pressure control device 73. The coating weight measuring unit 71 is responsible for measuring coating weight of the steel strip that has passed through a space defined between the first and the second air knife 3, 4. The coating weight control unit 72 compares an actual coating weight measured in the coating weight measuring unit 71 with the desired coating weight and then adjusts a spray pressure set value to reach the desired coating weight. The pressure control device 73 controls an air valve 8 in order for air jets to be sprayed under the pressure set in the coating weight control unit 72. The coating weight control unit 72 comprises a parameter estimator 721; a coating weight mathematical model 723 that receives the measured coating weight value and thus feedback controls the set pressure value to reach the desired coating weight; a preset control device 724 that outputs a set pressure value at the time when the desired coating weight varies; and a feed forward control device 725. The detailed descriptions of the functions and constructions thereof are as follows.

With reference to the coating weight mathematical model 723, the coating weight W is expressed as the following formula 10 using three parameters α, β and γ, a distance D between the steel strip and the air knives, an air pressure P of the air knives and a line speed V that is a feed rate of the steel strip. The respective variables are represented as Vₖ, Dₖ and Pₖ at the present time k. In this case, the coating weight is Wₖ. At next time of k+1, the respective variables are represented as Vₖ₊₁, Dₖ₊₁, and Pₖ₊₁, and coating weight is Wₖ₊₁. The coating weight (Wₖ₊₁) at the time of k+1 is obtained using the following formula 10:

If ΔV=ln(Vₖ₊₁)−ln(Vₖ)

ΔD=ln(Dₖ₊₁)−ln(Dₖ)

ΔP=ln(Pₖ₊₁)−ln(Pₖ),

ΔW=ln(Wₖ₊₁)−ln(Wₖ),

then, ΔW=αV+βD+γP. Formula 10

The above variables V, D and P are measured constantly.

The preset control device 724 is used at the time when the desired coating weight of the steel strip varies. Where the desired coating weight of the steel strip is changed from Tₖ to Tₖ₊₁, the set pressure value (Pₖ₊₁) of the air knives at the time of k+1 is obtained using the following formula 11:

$$ln ( {P}_{k + 1} ) = ln ( {P}_{k} ) + \frac{ln ( {T}_{k + 1} ) - ln ( {T}_{k} )}{γ} \qquad Formula 11$$

The feed forward control device 725 is used at the time when the feed rate of the steel strip varies. Where the feed rate of the steel strip is changed from Vₖ to Vₖ₊₁, the set pressure value (Pₖ₊₁) at the time of k+1 is obtained using the following formula 12:

$$ln ( {P}_{k + 1} ) = ln ( {P}_{k} ) + \frac{α [ ln ( {V}_{k + 1} ) - ln ( {V}_{k} ) ]}{γ} \qquad Formula 12$$

The parameter estimator 721 acts to optimize three parameters α, β and γ of the formula 10. Where the parameters α, β and γ are incorrect, an error between a coating weight (Wₖ₊₁) calculated in the formula 10 and an actual coating weight measured in the coating weight measuring unit 71 occurs. The parameter estimator 230 for minimizing such an error estimates the parameters of the coating weight mathematical model based on an optimizing technique called the recursive least square method, a scientific terms in linear algebra.

In the parameter estimator 230, the following equation 13 is used on the basis of the recursive least square method.

In detail, at present time k, where the respective variables are Vₖ, Dₖ and Pₖ, an actual coating weight measured in the coating weight measuring unit 71 is represented as \overline{Wₖ}. At next time of k+1, where the respective variables are Vₖ₊₁, Dₖ₊₁ and Pₖ₊₁, an actual coating weight measured in the coating weight measuring unit 71 is represented as \overline{Wₖ₊₁}. Parameters α, β and γ at the time of k+1 are obtained using the following formula 13:

If zₖ₊₁=Δ\overline{Wₖ₊₁}=ln(\overline{Wₖ₊₁})−ln(\overline{Wₖ}),

$$\begin{matrix}{h}_{k + 1} = ( \begin{matrix}\begin{matrix}Δ {V}_{k + 1} \\ Δ {D}_{k + 1}\end{matrix} \\ Δ {P}_{k + 1}\end{matrix} ) = ( \begin{matrix}\begin{matrix}ln ( {V}_{k + 1} ) - ln ( {V}_{k} ) \\ ln ( {D}_{k + 1} ) - ln ( {D}_{k} )\end{matrix} \\ ln ( {P}_{k + 1} ) - ln ( {P}_{k} )\end{matrix} ) , \\ {θ}_{k} = ( \begin{matrix}\begin{matrix}{α}_{k} \\ {β}_{k}\end{matrix} \\ {γ}_{k}\end{matrix} ) , {θ}_{k + 1} = ( \begin{matrix}\begin{matrix}{α}_{k + 1} \\ {β}_{k + 1}\end{matrix} \\ {γ}_{k + 1}\end{matrix} ) ,\end{matrix}$$

θₖ₊₁=θₖ+Kₖ₊₁[z_{k+z}−h′ₖ₊₁θₖ] Formula 13

In summary, the coating weight mathematical model 723 outputs a set pressure value for reaching a desired coating weight depending on an actual coating weight measured in the coating weight measuring unit 71. Where the desired coating weight is changed, the preset control device 724 outputs a set pressure value using the formula 11. Where the line speed is changed, the feed forward control device 725 outputs a set pressure value depending on variation in the line speed using the formula 12.

The set pressure values that are output according to the respective conditions are applied to the pressure control device 73. The pressure control device 73 adjusts a degree of opening and closing the air valve 8 depending on the output value of the coating weight control unit 72, resulting in a spray pressure being adjusted.

As described above, in accordance with the third embodiment of the present invention, pressure of air knife can be accurately controlled when a desired coating weight or a line speed varies. As a result, a difference between the desired coating weight and the actual coating weight can be minimized. Furthermore, poor products due to insufficient coating and zinc loss due to excess coating are maximally prevented, resulting in production cost savings. Because the parameter estimator of the present invention adapts the coating weight mathematical model while taking into consideration variations occurring whenever air knife equipment and other coating weight related equipments are periodically repaired, burden on equipment repair is decreased.

The respective coating weight control apparatuses according to the first, second and third embodiments can be used alone or in combination. However, where they are applied together in continuous hot dip galvanizing equipment, more accurate control of coating weight can be accomplished.

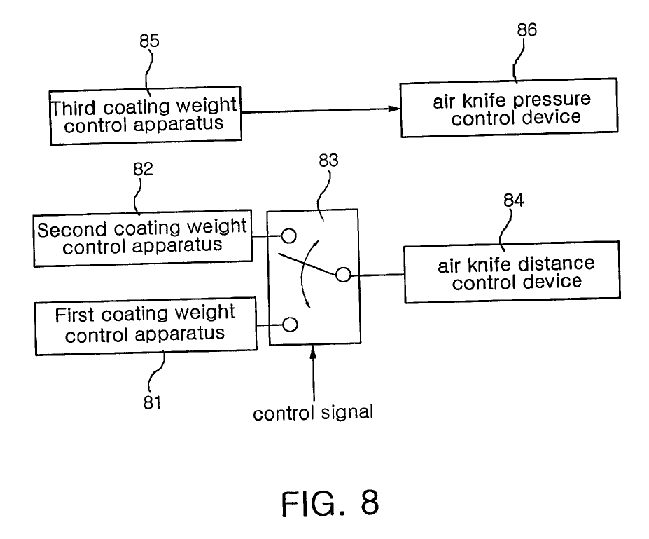

FIG. 8 is a block diagram showing a coating weight control system in a continuous hot dip galvanizing process into which the respective apparatuses according to the first, second and third embodiments of the present invention are integrated. The system comprises a first coating weight control apparatus 81, a second coating weight control apparatus 82, a switching device 83, an air knife distance control device 84, a third coating weight control apparatus 85, and an air knife pressure control device 86. The first coating weight control apparatus 81 measures distances to the second air knife from multiple measuring points on the steel strip, and changes the positions of both ends of each of the first and the second air knife from the measured multiple distances, thereby positioning the steel strip to be parallel with each air knife and to keeping the steel strip equidistant from each knife. The second coating weight control apparatus 82 changes the positions of the first and the second air knife to compensate for the movement of the passing line depending on a thickness difference between two steel strips during a predetermined time before and after passage of the welded portion. The switching device 83 connects the air knife distance control device 84 with the second coating weight control apparatus 82 during a predetermined time before and after passage of the welded portion, and connects the air knife distance control device 84 with the first coating weight control apparatus 83 after passage of the welded portion. The air knife distance control device 84 adjusts the positions of both ends of each of the first and the second air knife according to control of the first and the second coating weight control apparatus 81, 82. The third coating weight control apparatus 85 adjusts a spray pressure depending on variation in a desired coating weight and/or a line speed of the steel strip. The air knife pressure control device 86 controls a spray pressure applied to the first and the second air knife according to control of the third coating weight control apparatus 85.

The first coating weight control apparatus 81 is according to the first embodiment of the present invention as shown in FIGS. 3 and 4, the second coating weight control apparatus 82 is according to the second embodiment of the present invention as shown in FIG. 5, and the third coating weight control apparatus 85 is according to the third embodiment of the present invention as shown in FIG. 7.

The coating weight control system controls the spray pressure of the first and the second air knife according to variations in a desired coating weight and line speed using the third coating weight control apparatus 83 in a continuous hot dip galvanizing process where two or more steel strips are welded and then continuously coated.

The welded portion joining two steel strips that are different in thickness is subjected to control of the second coating weight control apparatus 82 during a predetermined time before and after passing through the coating bath. Therefore, distances between each of the first and the second air knife and the steel strip are controlled according to movement of the passing line depending on the thickness variation of the steel strips. The remaining portions (regions between the welded portions) are subjected to control of the first coating weight control apparatus 81 in a feedback manner, thereby resulting in each of the first and the second air knife and the steel strip being parallel with each other and the steel strip being kept equidistant from each air knife.

Therefore, the system can control continuous hot dip galvanizing equipments in a manner such that a desired coating weight can be coated regardless of variation in a continuous hot dip galvanizing process.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. An apparatus for controlling coating weight on a steel strip in a continuous hot dip galvanizing process, in which a first and a second air knife are equipped to control coating weight on the steel strip by spraying air jets of a predetermined pressure on both surfaces of the steel strip that has passed through a molten zinc coating bath, comprising:
multiple distance measuring means, which is installed to be separated by a predetermined distance from each other in the center of a support shaft that is positioned in a line with the second air knife and measures a distance between the steel strip and the air knife;
a distance adjusting means, which adjusts respective distances between each of the first and the second air knife and the steel strip while moving forward and backward both ends of each of the first and the second air knife;
a width measuring means, which measures the width of the steel strip; and
a position adjusting means for the distance measuring means, which allows the distance measuring means to be positioned in a widthwise center of the steel strip depending on sensing results of the width measuring means.

2. The apparatus as set forth in claim 1, wherein the width measuring means consists of a first and a second width sensor, each of which comprises a light emitting part on the first air knife and a light receiving part on the support shaft that is positioned in a line with the second air knife and is installed on opposite one ends of the first and the second air knife, and which determine the position and the width of the steel strip by detection of light by the light receiving part when the light emitting part transmits light.

3. The apparatus as set forth in claim 2, wherein the position adjusting means consists of:
a position adjusting motor which moves the support shaft in a widthwise direction of the steel strip, and in which the light receiving parts of the first and the second width sensor and the multiple distance measuring means are installed on the support shaft;
a motor position control device which drives the position adjusting motor; and
a first logic unit, which calculates the moving value of the position adjusting motor and then puts the calculated value into the motor position control device in order to equalize the amounts of light detected on the respective light receiving parts of the first and the second width sensor.

4. The apparatus as set forth in claim 2, wherein the respective light receiving parts of the first and the second width sensor comprise multiple photodiodes that are arranged to be separated by a predetermined distance from each other in a widthwise direction of the steel strip.

5. The apparatus as set forth in claim 4, wherein the first logic unit calculates the moving value of the distance measuring means as follows:
ΔGc=(Nws−Nds)×Pss
wherein,
ΔGc is a moving value of the distance measuring means, Nws is the number of light-sensing photodiodes in the first width sensor, Nds is the number of light-sensing photodiodes in the second width sensor, and Pss is a distance between photodiodes.

6. The apparatus as set forth in claim 1, wherein the distance measuring means consists of three or more distance sensors that are positioned to be separated by a predetermined distance from each other.

7. The apparatus as set forth in claim 6, wherein the distance adjusting means consists of:
four or more distance adjusting motors, which move forward and backward in a steel strip direction while being connected to both ends of each of the first and the second air knife;
a second logic unit, which calculates the moving values of both ends of each of the first and the second air knife using a distance between the steel strip and the second air knife that is measured by the distance sensors to thereby keep the steel strip equidistant from each air knife and to keep the steel strip parallel with each air knife; and
four or more motor position control devices which move the distance adjusting motors as far as the moving values of both ends of each of the first and the second air knife output from the second logic unit.

8. The apparatus as set forth in claim 7, wherein the second logic unit: a) defines an X-Y coordinate plane spanned by the X-axis of the forward/backward movement direction of the first and the second air knife and the Y-axis of the widthwise direction of the steel strip using a point as the origin; b) represents the curve of the steel strip on the X-Y coordinate plane as the following formula:
S(x):y=ax²+bx+c
(wherein, S(x) is a function to the curve of the steel strip on the X-Y coordinate plane, and a, b and c are coefficients of S(x)); c) changes multiple measurements obtained from the multiple distance measuring means into the X-Y coordinate values; d) puts the X-Y coordinate values into the function S(x) to obtain coefficients a, b and c; e) puts the obtained S(x) into the following formula:
$$Δ Y = \frac{[ {\int }^{W} ( S ( x ) - {L}_{T} ( x ) ) ⅆ x - {\int }^{W} ( {L}_{B} ( x ) - S ( x ) ) ⅆ x ]}{2 W}$$
(wherein, ΔY represents an average moving value of the first and the second air knife, W represents a width size of the steel strip detected by the width sensor, L_{T}(X) represents a linear equation of the nozzle of the first air knife, and L_{B}(x) represents a linear equation of the nozzle of the second air knife) thereby to obtain an average moving value of the first and the second air knife, ΔY; f) calculates the moving values of both ends of the first and the second air knife, ΔYds and ΔYws using the following formula:
$$Δ {Y}_{d S} = \frac{( {D}_{WS} - {D}_{dS} )}{2} \frac{M}{{G}_{SS}} , Δ {Y}_{WS} = - \frac{( {D}_{WS} - {D}_{dS} )}{2} \frac{( L - M )}{{G}_{SS}}$$
(wherein, ΔYds is a moving value of one end of the first and the second air knife, ΔYws is a moving value of the other end of the first and the second air knife, M is a straight line distance between a distance measuring means positioned at the center among multiple distance measuring means and a distance adjusting means which is connected with one end of the second air knife, and L is a distance between the two distance adjusting means which are positioned at both ends of the second air knife); and g) then calculates final moving values of both ends of each of the first and the second air knife, ΔY1, ΔY2, ΔY3 and ΔY4 using the following formulas:
ΔY1=−ΔY−ΔYws
ΔY2=−ΔY−ΔYds
ΔY3=ΔY+ΔYws
ΔY4=ΔY+ΔYds
(wherein, ΔY1 is a final moving value of one end (WS) of the first air knife, ΔY2 is a final moving value of the other end (DS) of the first air knife, ΔY3 is a final moving value of one end (WS) of the second air knife, and ΔY4 is a final moving value of the other end (DS) of the second air knife).

9. An apparatus for controlling coating weight on a steel strip in a continuous hot dip galvanizing process, in which a first and a second air knife are equipped to control coating weight on the steel strip by spraying air jets of a predetermined pressure on both surfaces of the steel strip that has passed through a molten zinc coating bath, comprising:
a position adjusting means for adjusting positions of the first and the second air knife;
a welded portion sensing means for detecting a changing position of a welded portion joining two steel strips that are different in thickness in a molten zinc coating bath;
a distance measuring means for measuring a distance between the second air knife and the steel strip;
a moving distance predictive logic means for calculating a moving distance of each of the first and the second air knife by calculating a thickness variation of a preceding steel strip and a following steel strip welded thereto and a moving value of the passing line of the steel strips on the basis of thickness information of the steel strips;
a moving distance measuring logic means for calculating a moving distance of each of the first and the second air knife by calculating a moving value of the passing line of the steel strips before and after passage of the welded portion using a distance between the steel strip and the second air knife that is measured by the distance measuring means;
a parameter correction means for correcting the parameters of the moving distance predictive logic means in order to compensate for an error between the predicted moving distance in the moving distance predictive logic means and the measured moving distance in the moving distance measuring logic means;
a switching means, which chooses between moving distances of the first and the second air knife output from the moving distance predictive logic means and those output from the moving distance measuring logic means, and then applies the chosen moving distance values to the position adjusting means; and
a switching control unit for applying the output value of the moving distance measuring logic means to the position adjusting means, with the exception of applying the output value of the moving distance predictive logic means to the position adjusting means during a predetermined time before and after the welded portion passes through the first and the second air knife, based on a changing position of the welded portion detected by the welded portion sensing means.

10. The apparatus as set forth in claim 9, wherein the moving distance predictive logic means inputs thickness of each of the preceding/following steel strips and thickness difference therebetween into the following formula:
$$\hat{S} = α {T}_{1} \frac{Δ T}{\vert Δ T \vert} + βΔ T$$
(wherein, Ŝ is a predicted moving value of the passing line, T₁ is a thickness of the preceding steel strip, ΔT is a thickness difference between the preceding steel strip and the following steel strip, and α and β are predictor variables), thereby to calculate a predicted moving value of the passing line of the steel strips and then produce a predicted moving distance of each of the first and the second air knife depending on the moving value of the passing line.

11. The apparatus as set forth in claim 9, wherein the moving distance measuring logic means receives measured distance values between each of the preceding/following steel strips and the second air knife from the distance measuring means and then calculates an actual moving value of the passing line of the steel strips using the following formula:
S=(D₂−D₁)−(P₂−P₁)
wherein,
S is an actual moving value of the passing line, D₁ is a distance between the preceding steel strip and the second air knife, D₂ is a distance between the steel strip and the second air knife after passage of the welded portion, P₁ is a position of the second air knife before passage of the welded portion, and P₂ is a position of the second air knife after passage of the welded portion.

12. The apparatus as set forth in claim 9, wherein the parameter correction means corrects operating parameters of the moving distance predictive logic means according to the following formulas:
$$\begin{matrix}α ( t + 1 ) = α ( t ) + {γ}_{α} \frac{\partial ( S - \hat{S} )}{\partial α} = α ( t ) - {γ}_{α} {T}_{1} \frac{Δ T}{\vert Δ T \vert} \\ β ( t + 1 ) = β ( t ) + {γ}_{β} \frac{\partial ( S - \hat{S} )}{\partial β} = β ( t ) - {γ}_{β} Δ T\end{matrix} ,$$
wherein, γ_{α}>γ_{β} are learning rates of α, β.

13. An apparatus for controlling coating weight on a steel strip in a continuous hot dip galvanizing process, in which a first and a second air knife are equipped to control coating weight on the steel strip by spraying air jets of a predetermined pressure on both surfaces of the steel strip that has passed through a molten zinc coating bath, comprising:
a coating weight measuring means for measuring coating weight on the steel strip that has passed through the first and the second air knife;
a coating weight mathematical model for calculating coating weight variation using respective parameters α, β and γ for compensating for variations in a feed rate of the steel strip, a distance between each air knife and the steel strip, and a pressure of the air knives;
a parameter correction means for correcting the parameters α, β and γ in order to minimize a difference between an actual coating weight value measured in the coating weight measuring means and a calculated coating weight value calculated in the coating weight mathematical model;
a first pressure control means for adjusting spray pressure of the first and the second air knife to conform the coating weight of the steel strip to the desired coating weight when the desired coating weight of the steel strip is changed; and
a second pressure control means for adjusting spray pressure of the air knives to compensate for the coating weight variation depending on variation in the feed rate of the steel strip when the feed rate of the steel strip is changed, characterized in that the spray pressure of the first and the second air knife is adjusted using output values of the first pressure control means and/or the second pressure control means when the desired coating weight and/or the feed rate are changed during a continuous hot dip galvanizing process under a predetermined pressure.

14. The apparatus as set forth in claim 13, wherein the coating weight mathematical model receives the feed rate variation of the steel strip (ΔV), the distance variation between the steel strip and the air knives (ΔD), and the pressure variation of the air knives (ΔP) according to the following formula:
ΔV=ln(Vₖ₊₁)−ln(Vₖ)
ΔD=ln(Dₖ₊₁)−ln(Dₖ)
ΔP=ln(Pₖ₊₁)−ln(Pₖ);
multiplies above respective variations by corresponding parameters α, β and γ thereby to obtain the formula, ΔW=αΔV+βΔD+γΔP; and then calculates the coating weight variation, ΔW=ln(Wₖ₊₁) ln(Wₖ).

15. The apparatus as set forth in claim 13, wherein the first pressure control means produces the set pressure value of the air knives (Pₖ₊₁) at the desired coating weight of Tₖ₊₁ using the following formula when the desired coating weight of the steel strip is changed from Tₖ to Tₖ₊₁:
$$ln ( {P}_{k + 1} ) = ln ( {P}_{k} ) + \frac{ln ( {T}_{k + 1} ) - ln ( {T}_{k} )}{γ}$$

16. The apparatus as set forth in claim 13, wherein the second pressure control means produces the set pressure value of the air knives (Pₖ₊₁) at the feed rate of Vₖ₊₁ using the following formula when the feed rate of the steel strip is changed from Vₖ to Vₖ₊₁:
$$ln ( {P}_{k + 1} ) = ln ( {P}_{k} ) + \frac{α [ ln ( {V}_{k + 1} ) - ln ( {V}_{k} ) ]}{γ}$$

17. The apparatus as set forth in claim 13, wherein the parameter correction means corrects the parameters α, β and γ using the following formulas when a difference between an actual coating weight measured in the coating weight measuring means and a calculated coating weight in the coating weight mathematical model is detected:
θₖ₊₁=θₖ+Kₖ₊₁[z_{k+z}−h′ₖ₊₁θₖ]
(wherein, zₖ₊₁=Δ\overline{Wₖ₊₁}=ln(\overline{Wₖ₊₁})−ln(\overline{Wₖ})
$$\begin{matrix}( wherein , {z}_{k + 1} = Δ \overline{{W}_{k + 1}} = ln ( \overline{{W}_{k + 1}} ) - ln ( \overline{{W}_{k}} ) \\ {h}_{k + 1} = ( \begin{matrix}\begin{matrix}Δ {V}_{k + 1} \\ Δ {D}_{k + 1}\end{matrix} \\ Δ {P}_{k + 1}\end{matrix} ) = ( \begin{matrix}\begin{matrix}ln ( {V}_{k + 1} ) - ln ( {V}_{k} ) \\ ln ( {D}_{k + 1} ) - ln ( {D}_{k} )\end{matrix} \\ ln ( {P}_{k + 1} ) - ln ( {P}_{k} )\end{matrix} ) \\ {θ}_{k} = ( \begin{matrix}\begin{matrix}{α}_{k} \\ {β}_{k}\end{matrix} \\ {γ}_{k}\end{matrix} ) , {θ}_{k + 1} = ( \begin{matrix}\begin{matrix}{α}_{k + 1} \\ {β}_{k + 1}\end{matrix} \\ {γ}_{k + 1}\end{matrix} ) ) . \end{matrix}$$

18. A system for controlling coating weight on a steel strip in a continuous hot dip galvanizing process, in which a first and a second air knife are equipped to control coating weight on the steel strip by spraying air jets of a predetermined pressure on both surfaces of the steel strip that has passed through a molten zinc coating bath, comprising:
a first coating weight control apparatus, measuring distance values between the steel strip and each of the first and the second air knife at multiple measuring points and changing positions of both ends of each of the air knives using the measured multiple distance values, thereby to align the steel strip to be parallel with each air knife and to keep the steel strip equidistant from each air knife;
a second coating weight control apparatus, changing position of each of the first and the second air knife thereby to correct the movement of the passing line depending on thickness difference of two steel strips during a predetermined time before and after passage of the welded portion of the two steel strips;
a third coating weight control apparatus, varying a spray pressure depending on variation in the desired coating weight and/or the feed rate of the steel strip;
an air knife distance control device, adjusting positions of both ends of each of the first and the second air knife using the second coating weight control apparatus for a predetermined time before and after passage of the welded portion and adjusting positions of both ends of each of the first and the second air knife using the first coating weight control apparatus after passage of the welded portion; and
an air knife pressure control device, adjusting a spray pressure to be sprayed from the first and the second air knife using the third coating weight control apparatus.
